(19) United States
(12) Patent Application Publication
(10) Pub. No.: US 2004/0155452 A1
(43) Pub. Date: Aug. 12, 2004

(54) TIME MANAGEMENT WORKBOOK FOR A PERSONAL SUCCESS SYSTEM

(76) Inventor: Christina A. Sfassie, Windermere, FL (US)

Correspondence Address: EDWARD M. LIVINGSTON, PA, 963 TRAIL TERRACE DRIVE, NAPLES, FL, 34103, US

(21) Appl. No.: 10/365,825

(22) Filed: Feb. 12, 2003

(51) Int. Cl. B42F 21/00

(52) U.S. Cl. 283/38

(57) ABSTRACT

A personal success system includes a system loose-leaf binder (1) of a convenient size containing predeterminedly formatted sheets that can include a Flash! Action Marker (39) used in conjunction with Flash! Action Sticky Notes (37), a life-goal sheet (2), monthly overview sheets (4), daily repeat task sheets (12), weekly repeat task sheets (20), special project sheets (28), a key contact card (40) and an attendance roster (41) for recording, updating and evaluating tasks of plans for personal-interest factors that include life-long achievement, life-period achievement, education, healthcare, mental development, finance, family, community, religion, nation and any other personal-interest factor selectively. The formatted sheets include organization for yearly, monthly, weekly, daily and hourly scheduling by task for effective and convenient recording, updating and evaluating by hand and by computer selectively. A Student Success Diagnostic (56) is included for enabling students to score their strengths and weaknesses in the area of time management and productivity. A corresponding Student Success Tips Sheet (57) is included providing tips and techniques for overcoming points of weakness. A Habit Builder Series (38) is included for adaptation of the personal success system to all life stages, periods and pursuits.

### BACKGROUND OF THE INVENTION

This invention relates to systems for achieving personal success, education, ability, discipline, goals and accomplishment.

There are numerous known personal reminder systems, notebooks, journals, accounting and checkup systems. There are none, however, for achieving personal success, education, ability, discipline, goals and accomplishment with the aid of a repeat-task recording system in a manner taught by this invention.

Examples of most-closely related known but different systems and devices are described in the following patent documents:

| U.S. Pat. No.: | Inventor: | Issue Date: |
|---|---|---|
| 5,810,395 | Morgan | Sep. 22, 1998 |
| 5,090,733 | Bussiere | Feb. 25, 1992 |
| 4,384,855 | Walsh | May 24, 1983 |
| 6,217,076 | Howard, et al. | Apr. 17, 2001 |
| 2,883,765 | Blaine | Apr. 28, 1959 |
| 6,039,355 | Durand | Mar. 21, 2000 |
| 5,573,404 | Stawski, II | Nov. 12, 1996 |
| 4,776,799 | Walsh | Nov. 11, 1988 |

### SUMMARY OF THE INVENTION

Objects of patentable novelty and utility taught by this invention are to provide a personal success system which:

helps to develop personal goals and identities progressively from early childhood throughout life with increasing cognition;

aids in developing personal organization and discipline;

organizes educational activities and disciplines;

helps to identify and to evaluate personal thinking and innovation in relationship to societal norms;

overcomes anxieties, stress and depression with reality-testing;

aids logical decision-making for effective action;

helps to establish purposefully effective habits, human relations and attitudes;

helps to establish constructive creativity; and

benefits the world with the results.

This invention accomplishes these and other objectives with a personal success system that includes a system loose-leaf binder of a convenient size containing predeterminedly formatted sheets for recording, updating and evaluating plans for interest factors that include life-long achievement, life-period achievement, education, healthcare, mental development, finance, family, community, religion, nation and any other interest factor selectively. The formatted sheets include organization for yearly, monthly, weekly, daily, and hourly scheduling by task for effective and convenient recording, updating and evaluating by hand and by computer selectively.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is an open-book page-face view of a system loose-leaf binder opened to a FLASH ACTION MARKER, a partial view of a DREAM LIFE (life-goal) sheet, and subsequent section-page tabs for separating system sections of formatted sheets for recording and evaluating accomplishment of tasks for achieving personal objectives and an opposite-page sample of a KEY CONTACT CARD, an ATTENDANCE ROSTER CARD, and a FLASH ACTION STICKY NOTES PAD for the personal success system;

FIG. 2 is an open-book page-face view of the system loose-leaf binder opened to a formatted task sheet for a DREAM LIFE (life-goal) SHEET for the personal success system;

FIG. 3 is an open-book page-face view of the system loose-leaf binder opened to a formatted task sheet for a MONTHLY OVERVIEW SHEET and an opposite-page sample of a completed MONTHLY OVERVIEW SHEET and instructions for using a Monthly Overview Sheet for the personal success system;

FIG. 4 is an open-book page-face view of the system loose-leaf binder opened to a formatted task sheet for a DAILY REPEAT TASK SHEET and an opposite-page sample of a completed DAILY REPEAT TASK SHEET and instructions for using a Daily Repeat Task Sheet for the personal success system;

FIG. 5 is an open-book page-face view of the system loose-leaf binder opened to a formatted task sheet for a WEEKLY REPEAT TASK SHEET and an opposite-page sample of a completed WEEKLY REPEAT TASK SHEET and instructions for using a Weekly Repeat Task Sheet for the personal success system;

FIG. 6 is an open-book page-face view of the system loose-leaf binder opened to a formatted task sheet for a SPECIAL PROJECT SHEET and an opposite-page sample of a completed SPECIAL PROJECT SHEET and instructions for using a Special Project Task Sheet for the personal success system;

FIG. 7 is a page-face view of a KEY CONTACT CARD for the personal success system;

FIG. 8 is a page-face view of an ATTENDANCE ROSTER CARD for the personal success system;

FIG. 9 is a page-face view of a REVERSIBLE DOOR HANGER for the personal success system;

FIG. 10 is a page-face view of a FOUR YEAR CALENDAR for the personal success system;

FIG. 11 is a page-face view of a DREAM LIFE (life-goal) SHEET of the HABIT BUILDER SERIES and showing subsequent section-page tabs for separating system sections of formatted task sheets for recording and evaluating accomplishment of tasks for achieving personal objectives;

FIG. 12 is a page-face view of a MONTHLY OVERVIEW SHEET of the HABIT BUILDER SERIES and showing subsequent section-page tabs for separating system sections of formatted task sheets for recording and evaluating accomplishment of tasks for achieving personal objectives for the personal success system;

FIG. 13 is a page-face view of a DAILY REPEAT TASK SHEET of the HABIT BUILDER SERIES and showing subsequent section-page tabs for separating system sections of formatted task sheets for recording and evaluating accomplishment of tasks for achieving personal objectives;

FIG. 14 is a page-face view of a WEEKLY REPEAT TASK SHEET of the HABIT BUILDER SERIES and showing subsequent section-page tabs for separating system sections of formatted task sheets for recording and evaluating accomplishment of tasks for achieving personal objectives for the personal success system;

FIG. 15 is a page-face view of a SPECIAL PROJECT TASK SHEET of the HABIT BUILDER SERIES for the personal success system;

FIG. 16 is a page-face view of a STUDENT SUCCESS DIAGNOSTIC for the personal success system;

FIG. 17 is a page-face view of a corresponding STUDENT SUCCESS DIAGNOSTIC TIP SHEET for the personal success system;

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. | System loose-leaf binder |
| 2. | Dream Life (life-goal) Sheet |
| 3. | N/A |
| 4. | Monthly Overview Sheets |
| 5. | Date blocks |
| 6. | N/A |
| 7. | Month block |
| 8. | N/A |
| 9. | Prompts |
| 10. | Monthly Overview Sample |
| 11. | Monthly Overview instructions |
| 12. | Daily Repeat Task Sheet |
| 13. | Month block |
| 14. | Time block |
| 15. | Date block |
| 16. | Recordation lines |
| 17. | The (Daily Repeat) Task |
| 18. | Daily Repeat Task Sample |
| 19. | Daily Repeat Task instructions |
| 20. | Weekly Repeat Task Sheets |
| 21. | Week 1-Week 5 blocks |
| 22. | Check space |
| 23. | Recordation lines |
| 24. | Target week-day designation |
| 25. | The (Weekly Repeat) Task |
| 26. | Weekly Repeat Task Sample |
| 27. | Weekly Repeat Task instructions |
| 28. | Special Project Sheet |
| 29. | Blank target dates section |
| 30. | Blank action-item lines |
| 31. | Check space |
| 32. | Special Project designation |
| 33. | Due-date block |
| 34. | Title & Items Needed block |
| 35. | Special Project Sample |
| 36. | Special Project-procedure instructions |
| 37. | Sticky Notes Pad |
| 38. | Habit Builder Series |
| 39. | Flash! Action Marker |
| 40. | Key Contact Sheet |
| 41. | Attendance Roster |
| 42. | Year Calendar |
| 43. | Reversible Door Hanger |
| 43A. | Reversible Door Hanger |
| 44. | Student I.D. |
| 45. | Grade level |
| 46. | Absence reporting info |
| 47. | Date absent |
| 48. | Period(s) absent |
| 49. | Absenteeism comments |
| 50. | Excused absence check space |
| 51. | Unexcused absence check space |
| 52. | School/Principal info |
| 53. | Nurse info |
| 54. | Teacher(s) info |
| 55. | Other Key Contact info |
| 57. | Student Success Diagnostic |
| 57. | Student Success Diagnostic TIPs |
| | Sheet |
| 58. | Student Success Diagnostic |
| | designation |
| 59. | Student Success Diagnostic-use |
| | instructions |
| 60. | Student Success Diagnostic category |
| | designation |
| 61. | Student Success Statements |
| 62. | Self-scoring section |
| 63. | Total points per category designation |
| 64. | Vacant total points box |
| 65. | Level of Agreement designation |
| 66. | Student Success Diagnostic TIPs |
| | designation |
| 67. | TIPS-use instructions |
| 68. | TIPS category 1-6 designation |
| 69. | Success tips and techniques |

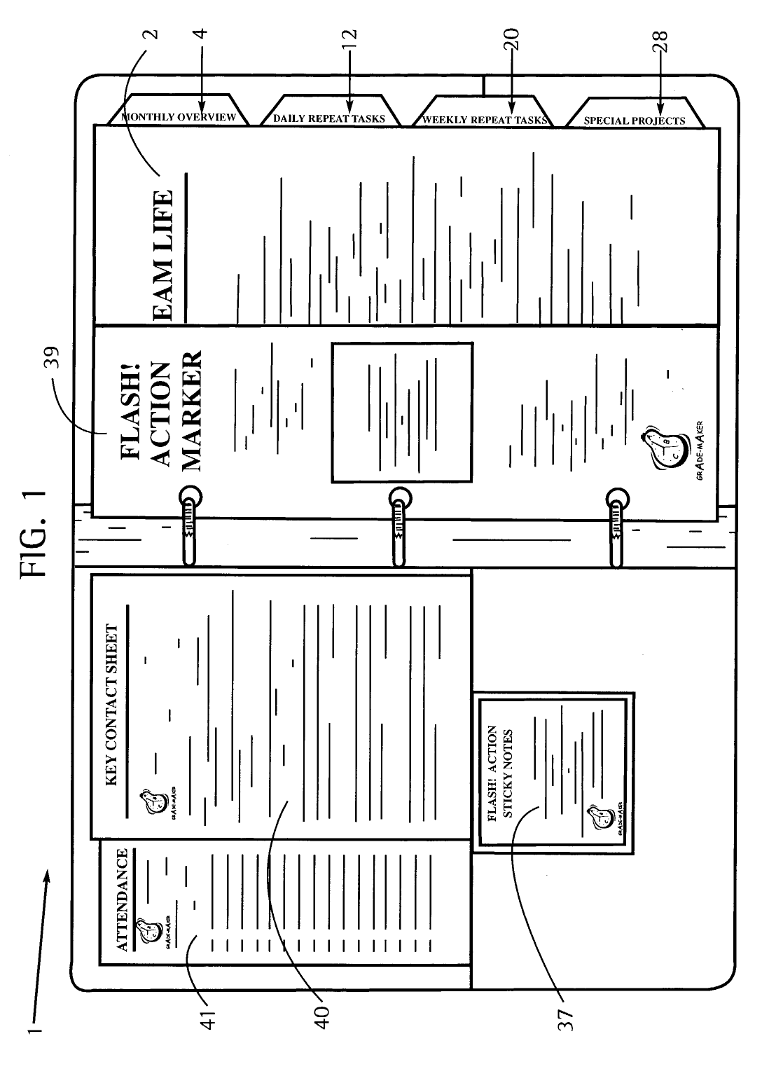

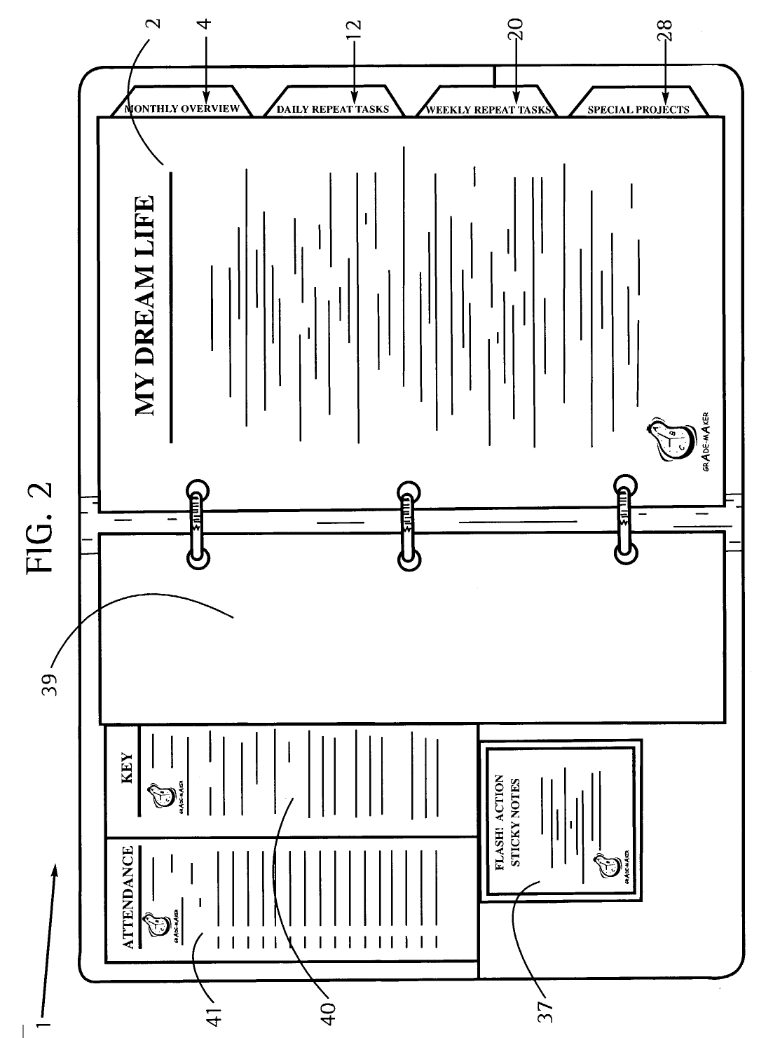

Referring to FIGS. 1-2, the personal success system includes a system loose-leaf binder 1 containing predeterminedly formatted task sheets, also referred to as task slips that are adapted for recording and evaluating accomplishment of tasks for achieving personal objectives. The formatted task sheets include calendar and time format adapted for scheduling tasks yearly, monthly, weekly, daily, and hourly as desired. The formatted sheets include format adapted for effective and convenient recording of tasks and recording of accomplishment of the tasks for evaluation selectively.

One Flash Action Marker 39 that is formatted for attaching at least one Flash Action Sticky Note titled and adapted to be hooked onto the system loose-leaf binder for prompting a user to take flash action as needed to accomplish random responsibilities day-by-day that do not require a task slip to avoid stress.

At least one life-goal sheet 2, characterized also for particular users as a Dream Life sheet that is formatted for recording life goals and dreams of accomplishment. The life-goal sheet(s) 2 has space thereon for recording modifications, changes and updating of the life goals and dreams of accomplishment progressively and occasionally with increasing cognition and experience.

At least one Key Contact Sheet 40 adapted for a responsible adult to record identities and contact data of key educational authorities, including the student, school, phone number, principal, address of school, nurse and teachers. Space for recording “Other Key Contacts” is provided on reverse.

At least one Attendance Roster 41 is adapted for a responsible adult to record excused and unexcused school absences and comments by the adult or school authorities.

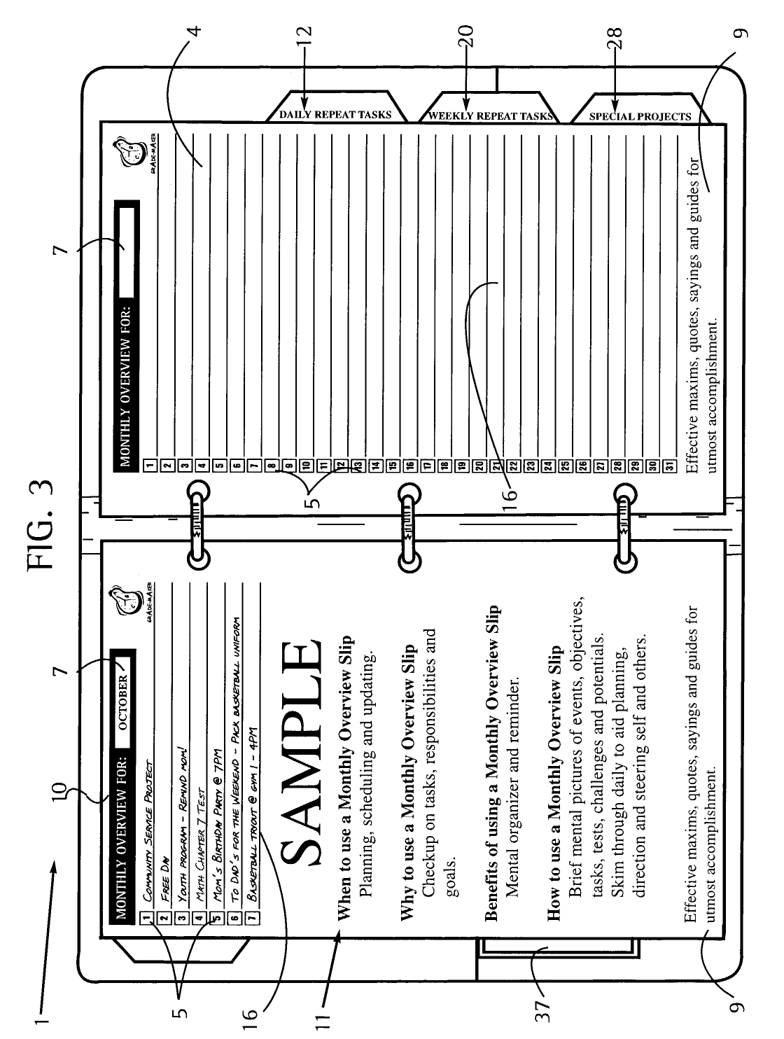

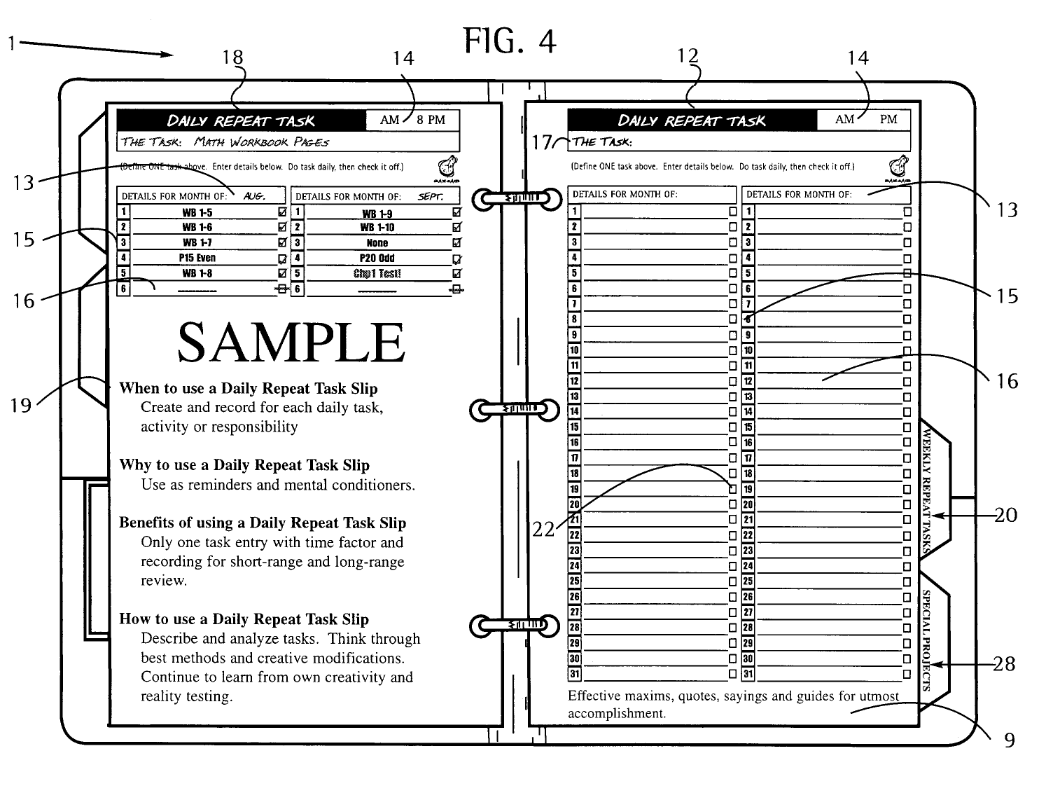

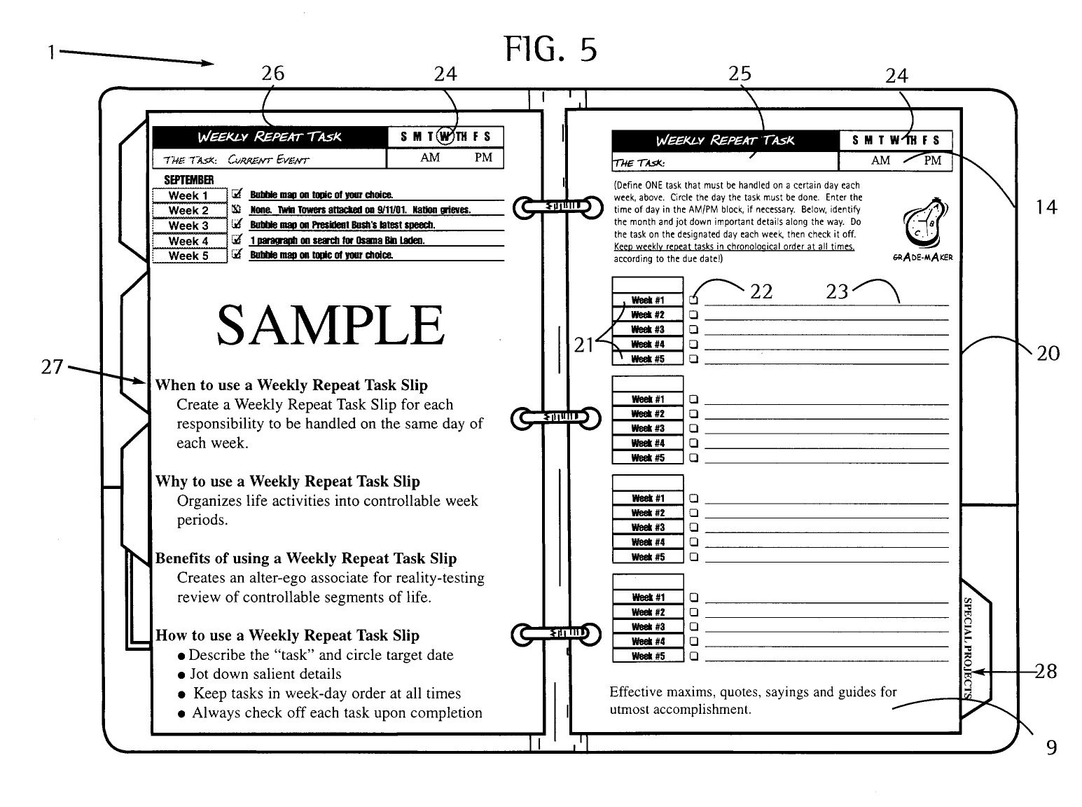

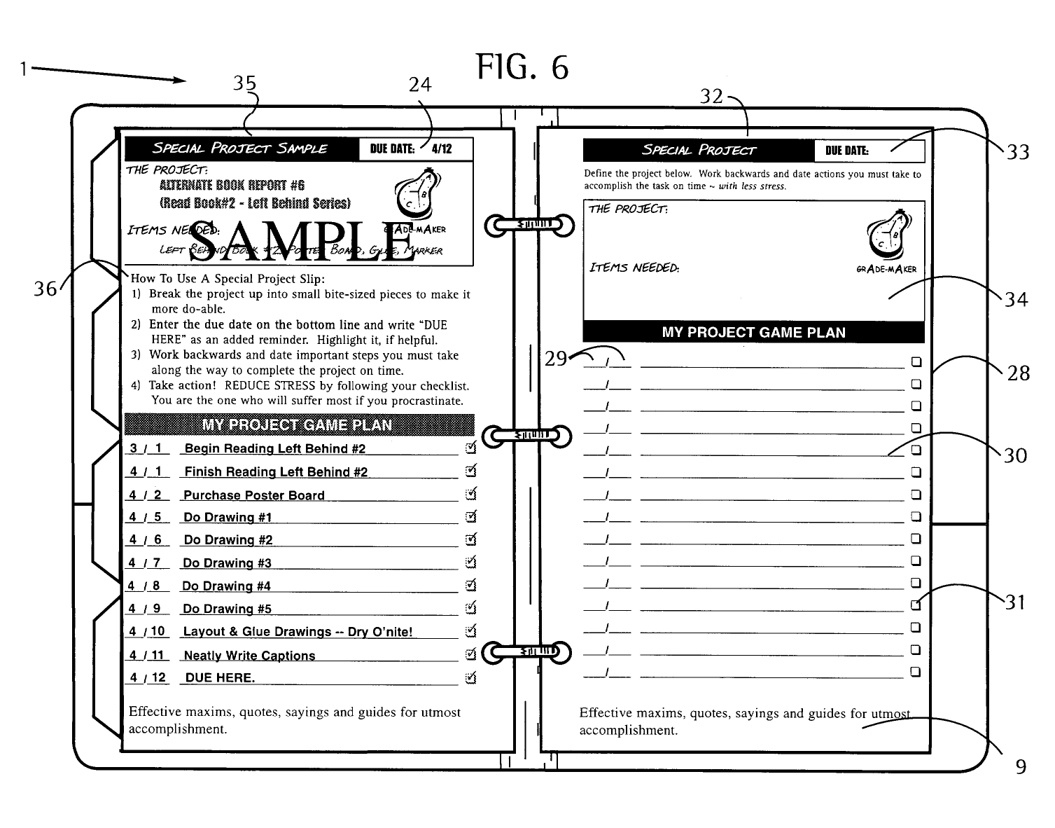

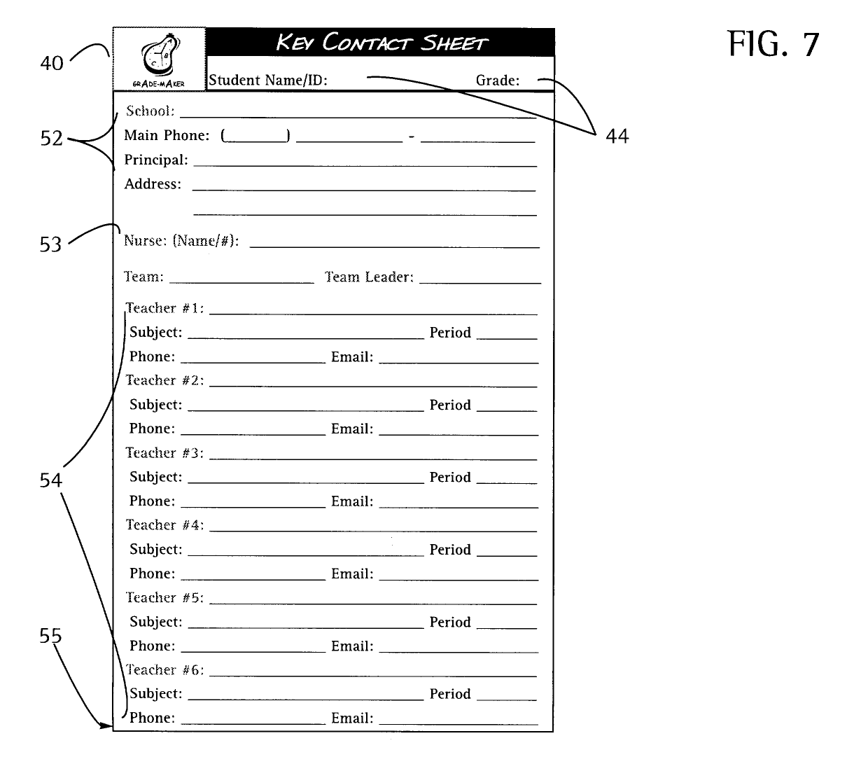

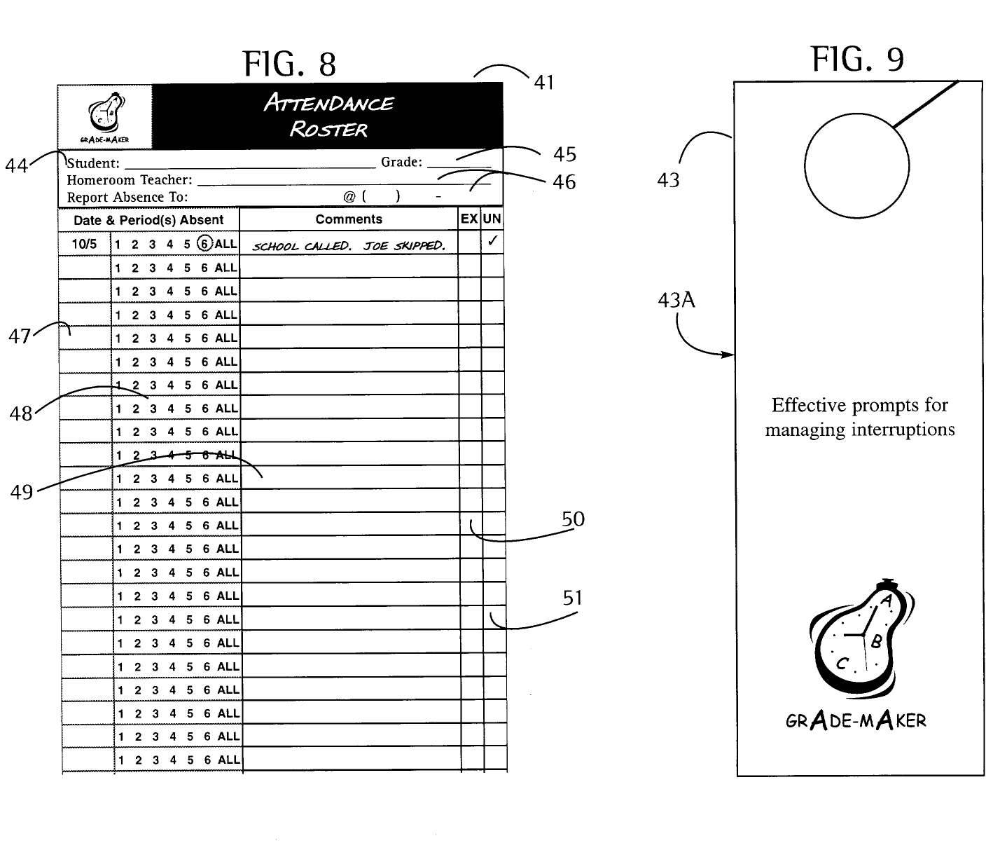

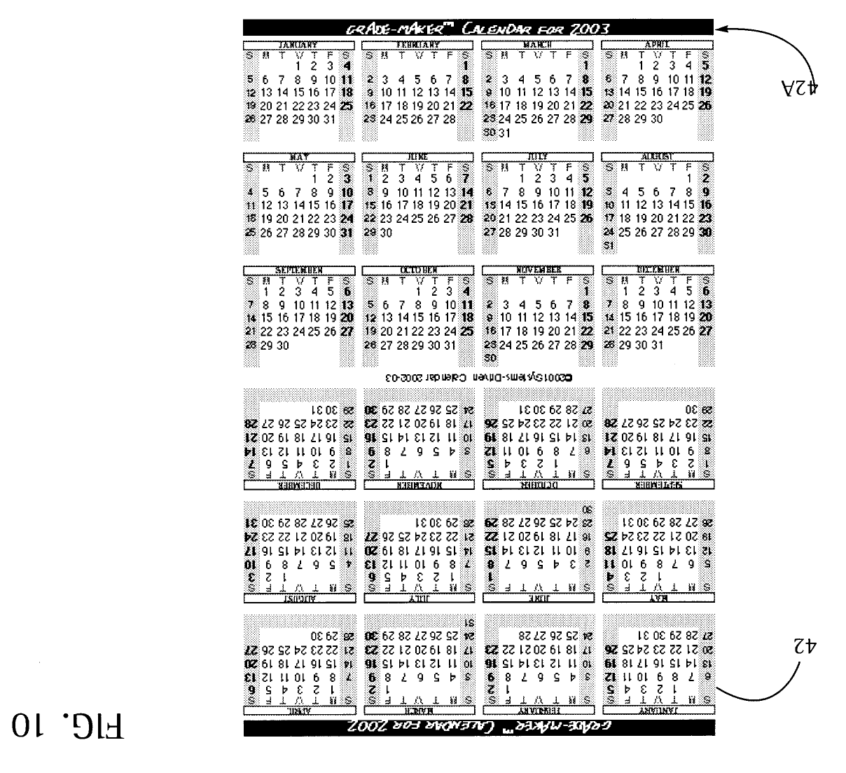

Referring to FIGS. 3-10, the personal success system includes formatted task sheets for achieving personal objectives which include an A-grade high school education with life preparation for utmost success in any chosen endeavor. The formatted task sheets include a plurality of Monthly Overview Sheets 4, each of which include one blank month block 7 for recording the name of each month for one calendar year and one set of 1-31 date blocks 5 representing each day of any given month with 31 adjacent recordation lines 16 for recording events, activities and responsibilities taking place on each day of the month.

The Monthly Overview Sheets 4 include grade-A prompts 9 with effective personal-development maxims, quotes, sayings and guides for utmost success selectively. An abstract morphed clock with A-C grades is illustrated as a prompt 9 to convey preferably artistic, attractive and convenient design, form and size of the system loose-leaf binder 1, the prompts 9 and the formatted task sheets or task slips for personal acceptance and preferences.

The system includes a Monthly Overview Sample 10 of preferably one week with sample selections of abbreviations of entries for a typical week of activities.

The Monthly Overview Sample 10 includes Overview-use instructions 11 that explain when to use, why to use, how to use and the benefits from use of the Monthly Overview Sheets.

The system includes a daily-tasks section having a plurality of Daily Repeat Task Sheets 12. The Daily Repeat Task Sheets 12 are captioned with predetermined grade-A prompts 9, followed by a space titled “THE TASK” 17 for identifying the task that is to be accomplished on a daily basis and an AM and PM block for recording the preferred time of day to accomplish The Task 17.

Each Daily Repeat Task Slip 12 includes two identical and adjacent recordation columns that include a blank Month block 13 for identifying the month in which The (Daily Repeat) Task 17 is to be accomplished. Directly beneath the month block are 31 designated date blocks 15 representing each day of any given month. Adjacent to each designated date block is a Recordation line 16 for recording relevant details about The (Daily Repeat) Task 17 throughout each corresponding month followed by a Check space 22 for checking the task off upon completion.

The daily repeat tasks section includes a Daily Repeat Task Sample 18 of preferably one Daily Repeat Task 17, seven date blocks 15, and adjacent recordation lines 16 with samples of details relevant to the designated task using a selection of abbreviations of entries and a checkmark reflecting completion of the task in a timely manner. The Daily Repeat Task Sample 18 includes Daily Repeat Task-use instructions 19 for when to use, why to use, how to use and benefits from use of the daily repeat task sheets 12.

The plurality of the Daily Repeat Task Sheets 12 includes a sufficient plurality thereof for recording entries for no less than ten Daily Repeat Tasks for twelve months;

The system includes a weekly-task section having a plurality of Weekly Repeat Task Sheets 20. Weekly Repeat Task Sheets 20 are captioned with predetermined grade-A prompts 9, a Target week-day designation 24 bar, a vacant space titled “THE TASK” 25 for identifying the task to be accomplished on the same day weekly, and an AM and PM block for recording the preferred time of day to accomplish The Task 25.

Each Weekly Repeat Task Sheet 20 includes five sets of Week 1-Week 5 blocks 21 representing each week in any given five months. An adjacent Check Space 22 is included for checking off the task upon completion followed by a Recordation line 23 for recording relevant details about the designated task week-by-week throughout each corresponding month.

The weekly repeat tasks section includes a Weekly Task Sample 26 of preferably one Weekly Repeat Task 25 and five weeks of selected abbreviations and entries relevant to accomplishing the designated weekly task. A checkmark represents completion of the weekly task in a timely manner. The Weekly Repeat Task Sample 26 includes Weekly Repeat Task instructions 27 for when to use, why to use, how to use and benefits from use of the Weekly Repeat Task Sheets 20.

The plurality of the Weekly Repeat Task Sheets 20 includes a sufficient plurality thereof for recording entries for no less than ten Weekly Repeat Tasks for twelve months.

The system includes a special-projects section having a plurality of Special Project Sheets 28. The Special Project Sheets 28 are captioned with predetermined grade-A prompts 9, with a SPECIAL PROJECT designation 32 followed by a blank Due date block 33, a large title box captioned “The Project”, and space for recording “Items Needed” 34 for accomplishing the project successfully.

Each Special Project Sheet 28 includes a printed designation of MY PROJECT GAME PLAN, below which are included a plurality of blank target dates spaces 29 for recording dates when certain tasks must be accomplished to complete the project on time with less anxiety and stress. Adjacent to the target dates 29 are blank action-item lines 30 for recording actions which must be taken to complete the task on time. A check space 31 is also included for checking off each action item upon completion by the designated target date 29.

The special-projects section includes a Special Project Sample 35 of about ten portions of a special project with target dates, a project due date, descriptions and checks for completion of each of the portions of the special project. The special project sample includes Special Project-procedure instructions 36 for breaking the project into easily doable portions, entering target dates and the due date, working backwards to determine the nature of the project for planning ahead, and taking action to avoid pain of anxiety from procrastination.

The system also includes one Flash Action Marker 39 that is formatted for attaching at least one Flash Action Sticky Note 37 titled and adapted to be hooked onto the system loose-leaf binder 1 for prompting a user to take flash action as needed to accomplish random responsibilities day-by-day that do not require a task slip to avoid stress.

Also included is a Key Contact Sheet 40 adapted for a responsible adult to record identities and contact data of key educational authorities, including the student, school, phone number, principal, address of school, nurse and teachers. Space for recording “Other Contacts” is provided on reverse. An Attendance Roster 41 is adapted for a responsible adult to record excused and unexcused school absences and comments by the adult or school authorities.

Also included is a 4-Year Calendar 42 for dating entries in the personal success system as needed and a reversible Door Hanger 43 and 43A which assists adults and students in working together to manage interruptions and increase productivity.

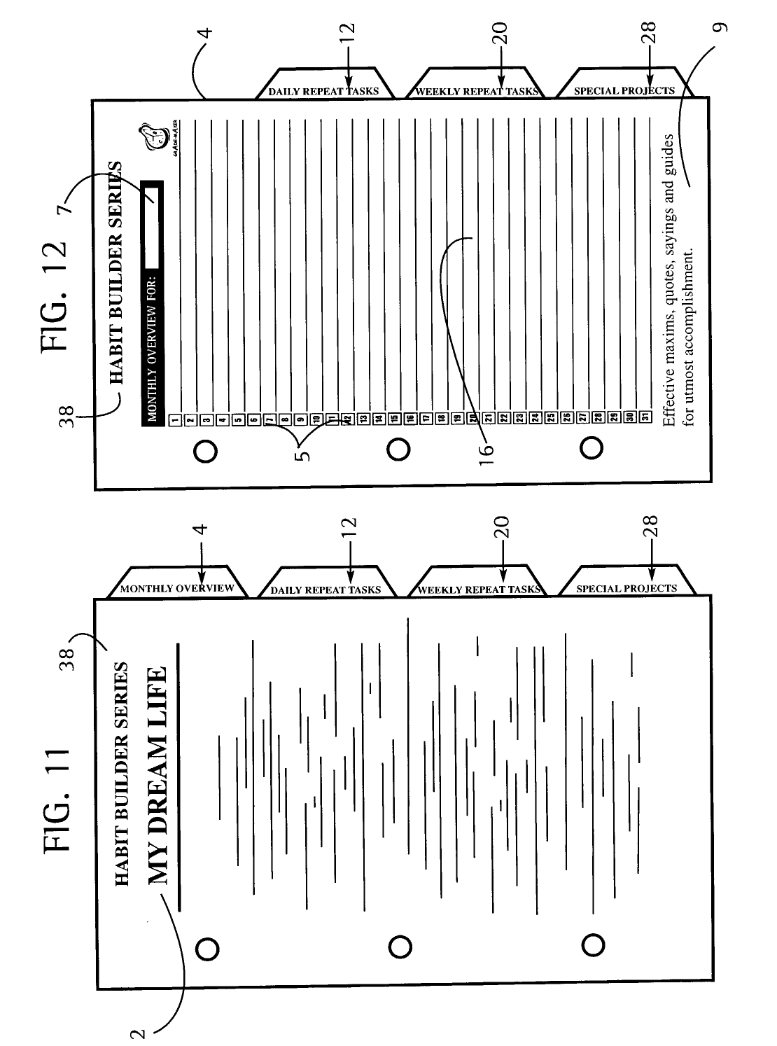

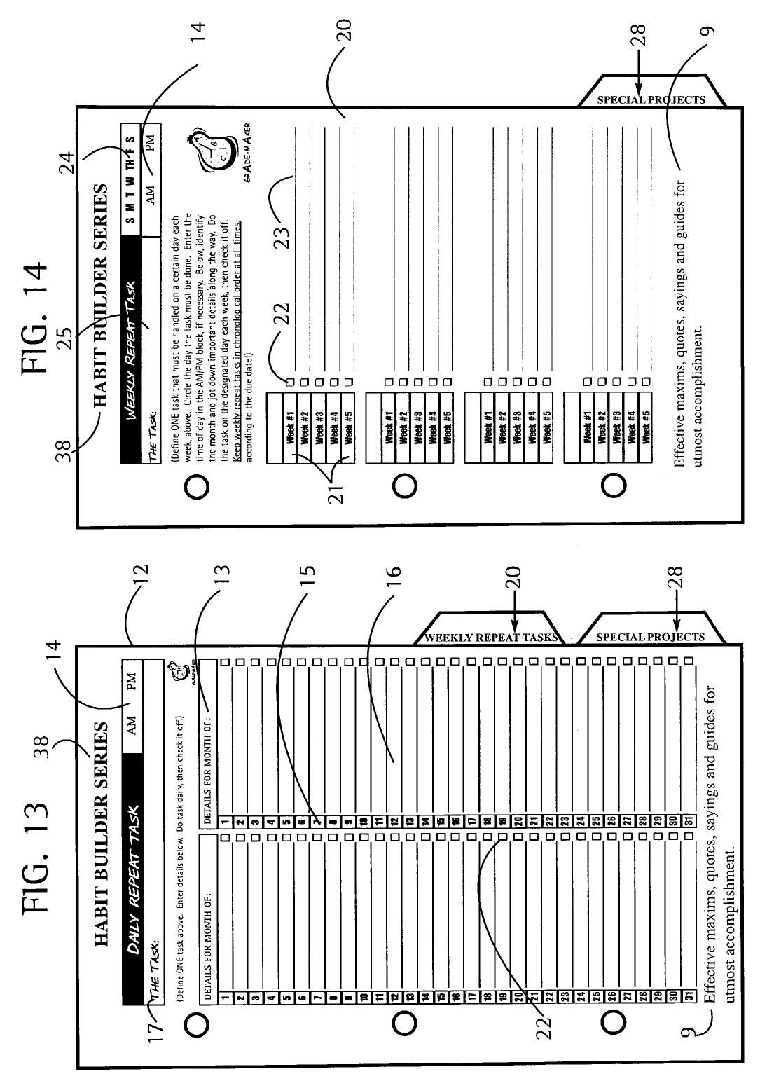

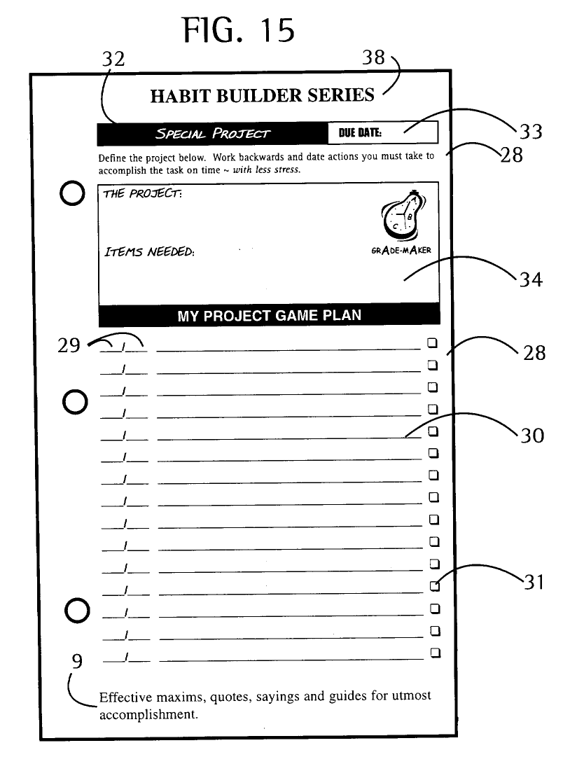

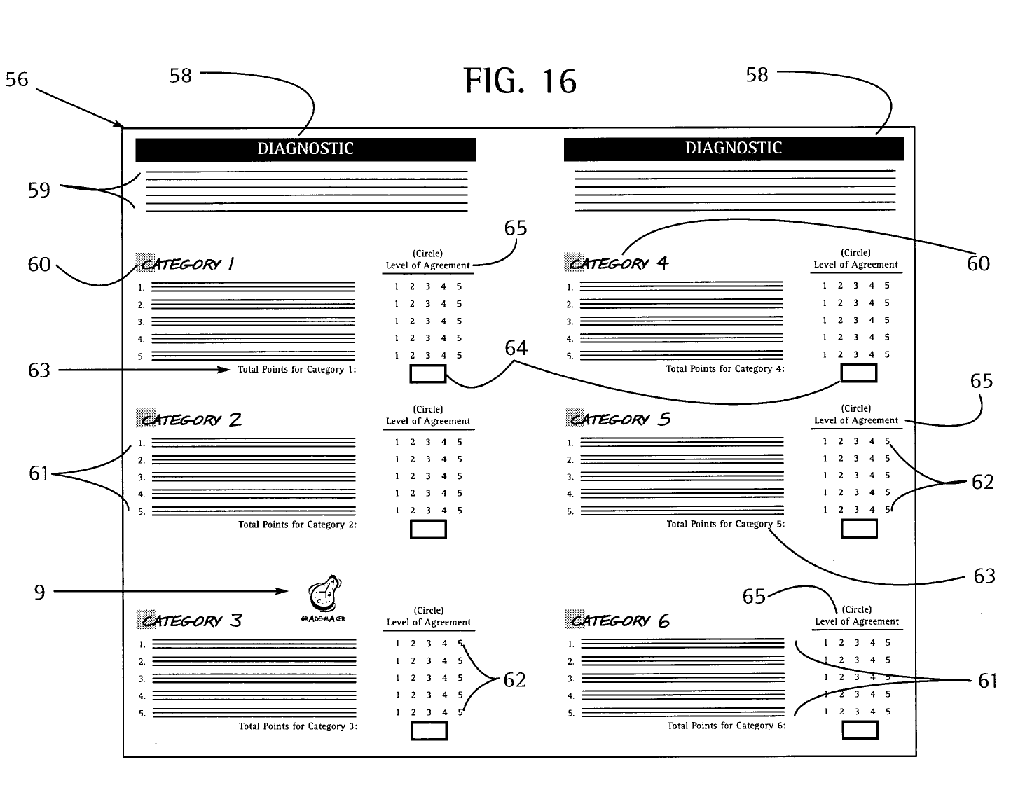

Referring to FIGS. 11-15, the formatted task sheets can include a Habit Builder Series 38. The personal objectives of the tasks of the Habit Builder Series 38 can include an ultimate-achievement education with life preparation for utmost success in any chosen endeavor. The Monthly Overview Sheets 4, the Daily Repeat Task Sheets 12, the Weekly Repeat Task Sheets 20 and the Special Project Sheet 28 can be utilized accordingly for higher education, for self-education, for professional life, for business, for creative pursuits, for political life, for religious pursuits, for family life and for any type or level of achievement.

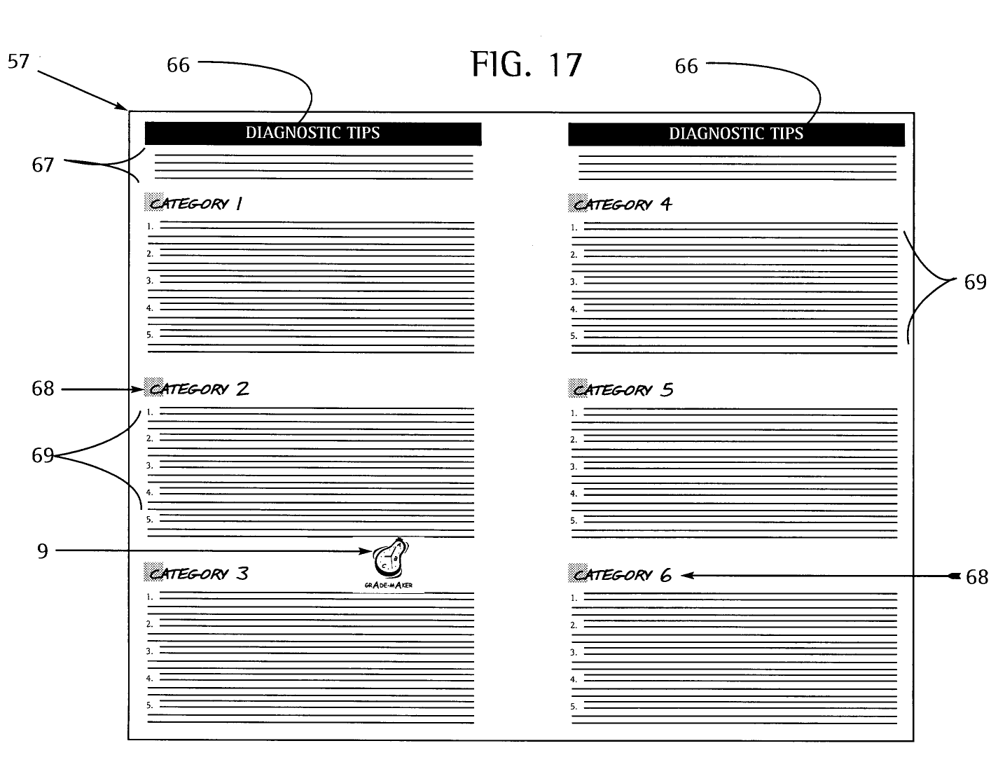

Referring to FIGS. 16-17, the system includes a Student Success Diagnostic 56 that enables students to identify their time management and productivity skills in six specific categories relevant to success and a corresponding Student Success Diagnostic Tips Sheet 57 which offers tips, techniques and insights into diagnosed areas of weakness.

A new and useful personal success system having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A personal success system comprising:
predeterminedly formatted task sheets for recording and evaluating accomplishment of tasks for achieving personal objectives;
the formatted task sheets including calendar and time format adapted for scheduling tasks yearly, monthly, weekly, daily, and hourly as desired;
the formatted task sheets including format for effective and convenient recording of tasks and recording of accomplishment of the tasks for evaluation selectively;
the formatted task sheets include at least one life-goal sheet that can be characterized also for particular users as a Dream-Life sheet that is formatted for recording life goals and dreams of accomplishment; and
the life-goal sheet having space thereon for recording modifications, changes and updating of the life goals and dreams of accomplishment progressively with increasing cognition and experience.

2. The personal success system of claim 1 wherein:
the personal objectives of the tasks include an A-grade high-school education with life preparation for utmost success in any chosen endeavor;
the formatted task sheets include a plurality of Monthly Overview sheets; and
the Monthly Overview sheets each include one blank month block for recording the name of each month for one calendar year and one set of 1-31 date blocks representing each day of any given month and 31 adjacent recordation lines for recording events, activities and responsibilities taking place on each day of the month.

3. The personal success system of claim 2 wherein:
the Monthly Overview sheets include grade-A prompts and effective personal-development maxims, quotes, sayings and guides for utmost success selectively.

4. The personal success system of claim 2 wherein:
the system includes a Monthly Overview Sample of preferably no less than seven days with sample selections of abbreviations of entries for a typical week of activities.

5. The personal success system of claim 4 wherein:
the Monthly Overview Sample includes Overview-use instructions.

6. The personal success system of claim 5 wherein:
the Overview-use instructions include when to use, why to use, how to use and benefits from use of the Monthly Overview sheets.

7. The personal success system of claim 2 wherein:
the Monthly Overview sheet includes one blank month block for recording the name of each month for one calendar year;
one set of 1-31 vertical date blocks starting with 1 as the first day and 31 as the last possible day of the month with 31 adjacent recordation lines for recording events, activities and responsibilities taking place on each day of any given month.

8. The personal success system of claim 2 further comprising:
a daily-tasks section having a plurality of Daily Repeat Task sheets;
each Daily Repeat Task Sheets are captioned with predetermined grade-A prompts followed by a space titled “THE TASK” for identifying the task that is to be accomplished on a daily basis and an AM and PM block for recording the preferred time of day to accomplish the task;
two identical and adjacent recordation columns that include a blank Month block for identifying the month in which The (Daily Repeat) Task is to be accomplished;
directly beneath the month block are 31 designated date blocks representing each day of any given month;
adjacent to each designated date block is a Recordation line for recording relevant details about The (Daily Repeat) Task throughout each corresponding month; and
followed by a Check space for checking the task off upon completion.

9. The personal success system of claim 8 wherein:
the Daily Repeat Task sheets are captioned with grade-A prompts and effective personal-development maxims, quotes, sayings and guides for utmost success selectively.

10. The personal success system of claim 8 wherein:
the daily-tasks section includes a Daily Repeat Task Sample of preferably seven designated date blocks; and
adjacent recordation lines showing samples of details relevant to the designated task using a selection of abbreviations of entries;
followed by a checkmark reflecting completion of the task in a timely manner.

11. The personal success system of claim 10 wherein:
the Daily Repeat Task Sample includes Daily Repeat Task-use instructions.

12. The personal success system of claim 11 wherein:
the Daily Repeat Task-use instructions include when to use, why to use, how to use and benefits from use of the Daily Repeat Task sheets.

13. The personal success system of claim 8 wherein:
the plurality of Daily Repeat Task sheets includes a sufficient plurality thereof for recording entries for no less than ten Daily Repeat Tasks during a twelve month period;

14. The personal success system of claim 2 further comprising:
the student success series includes a weekly-task section having a plurality of Weekly Repeat Task sheets;
each Weekly Repeat Task Sheet includes five sets of Week 1-Week 5 blocks representing each week in any given five months;
followed by a check space for checking off the task upon completion; and
and an adjacent Recordation line for recording relevant details about the designated task week-by-week throughout each corresponding month.

15. The personal success system of claim 14 wherein:
the weekly repeat task sheets are captioned with predetermined grade-A prompts, with a Target week-day designation block and with a vacant box titled “THE TASK” followed by AM and PM.

16. The personal success system of claim 14 wherein:
the weekly-task section includes a Weekly Task Sample of preferably seven days of weekly tasks; and
the weekly task sample includes a selection of abbreviations of entries for seven days of weekly tasks.

17. The personal success system of claim 16 wherein:
the weekly task sample includes Weekly Repeat Task-use instructions.

18. The personal success system of claim 17 wherein:
the Weekly Repeat Task-use instructions include when to use, why to use, how to use and benefits from use of the weekly repeat task sheets.

19. The personal success system of claim 8 wherein:
the plurality of weekly repeat task sheets includes a sufficient plurality thereof for recording entries for no less than ten Weekly Repeat Tasks for twelve months.

20. The personal success system of claim 2 wherein:
the system includes a special-projects section having a plurality of special project sheets;
the Special Project sheets each include a printed designation of MY PROJECT GAME PLAN, below which are included a plurality of blank target dates spaces for recording dates when certain tasks must be accomplished to complete the project on time with less anxiety and stress. Adjacent to the target dates are blank action-item lines for recording actions which must be taken to complete the task on time followed by a check space for checking off each action item upon completion by the designated target date.

21. The personal success system of claim 20 wherein:
the special project sheets are captioned with predetermined grade-A prompts with a SPECIAL PROJECT designation followed by a vacant Due date block;
included directly beneath is a large vacant title box captioned “The Project” and space for recording the “Items Needed” for accomplishing the project successfully.

22. The personal success system of claim 20 wherein The special-projects section includes a Special Project Sample with a titled project, the final project due date, and a list of “Items Needed” to accomplish the project successfully.

23. The personal success system of claim 22 wherein:
the special project sample includes project-procedure instructions

24. The personal success system of claim 17 wherein:
the project-procedure instructions for breaking the project into easily doable portions by working backwards from the final due date to determine a plan of action and the amount of time needed to accomplish the plan to avoid the pain of anxiety from procrastination.

25. A personal success system comprising:
predeterminedly formatted task sheets for recording and evaluating accomplishment of tasks for achieving personal objectives;
the formatted task sheets including calendar and time format adapted for scheduling tasks yearly, monthly, weekly, daily, and hourly as desired;
the formatted task sheets including format for effective and convenient recording of tasks and recording of accomplishment of the tasks for evaluation selectively;
the formatted task sheets including at least one Flash Action Marker that is formatted for attaching at least one Flash Action Sticky Note titled and adapted to be hooked onto the system loose-leaf binder for prompting a user to take flash action as needed to accomplish random responsibilities day-by-day that do not require a task slip to avoid stress.
the formatted task sheets including at least one life-goal sheet that can be characterized also for particular users as a Dream-Life sheet that is formatted for recording life goals and dreams of accomplishment;
the life-goal sheet having space thereon for recording modifications, changes and updating of the life goals and dreams of accomplishment progressively with increasing cognition and experience;
the personal objectives of the tasks including an A-grade high-school education with life preparation for utmost success in any chosen endeavor;
the formatted task sheets including a plurality of Monthly Overview sheets;
the Monthly Overview sheets each including one vacant month block for recording the name of each month for one calendar year;
one set of 1-31 date blocks representing each day of any given month and 31 adjacent recordation lines for recording events, activities and responsibilities taking place on each day of the month;
grade-A prompts and effective personal-development maxims, quotes, sayings and guides for utmost success selectively;
the Monthly Overview Sample of preferably no less than seven days with sample selections of abbreviations of entries for a typical week of activities;
the Monthly Overview Sample includes Overview-use instructions;
the Overview-use instructions include when to use, why to use, how to use and benefits from use of the Monthly Overview sheets;
the plurality of Daily Repeat Task sheets includes a sufficient plurality thereof for recording entries for no less than ten Daily Repeat Tasks during a twelve month period;
the Daily Repeat Task Sheets being captioned with predetermined grade-A prompts followed by a space titled “THE TASK” for identifying the task that is to be accomplished on a daily basis and an AM and PM block for recording the preferred time of day to accomplish the task;
the Daily Repeat Task Sheets each including two identical vertical and adjacent recordation columns;
both recordation columns including a vacant Month block for identifying the month in which The (Daily Repeat) Task is to be accomplished;
1-31 date blocks being positioned directly below the Month block representing each day of any given month;
a Recordation line being adjacent to each designated date block for recording relevant details about The (Daily Repeat) Task throughout each corresponding month;
a Check space immediately following the Recordation line for checking the task off upon completion;
the Daily Repeat Task sheets being captioned with predetermined grade-A prompts and effective personal-development maxims, quotes, sayings and guides for utmost success selectively;
the daily-tasks section including a Daily Repeat Task Sample of preferably seven designated date blocks;
recordation lines being adjacent to the designated date blocks showing samples of details relevant to the designated task using a selection of abbreviations of entries;
a checkmark immediately following the recordation lines reflecting completion of the task in a timely manner;
the Daily Repeat Task Sample including Daily Repeat Task-use instructions;
the Daily Repeat Task-use instructions include when to use, why to use, how to use and benefits from use of the Daily Repeat Task sheets;
the weekly-task section having a plurality of Weekly Repeat Task sheets including a sufficient plurality thereof for recording entries for no less than ten Weekly Repeat Tasks during a twelve month period;
the Weekly Repeat Task sheets being captioned with predetermined grade-A prompts including a Target week-day designation block and a vacant box titled “THE TASK” followed by AM and PM;
the Weekly Repeat Task Sheet including five sets of Week 1-Week 5 blocks representing each possible week in any given month;
a check space immediately following each Week 1-Week 5 block for checking off the task upon completion;
a Recordation line being adjacent to the check space for recording relevant details about the designated task week-by-week throughout each corresponding month;
the Weekly Repeat Task sheets being captioned with effective personal-development maxims, quotes, sayings and guides for utmost success selectively;
the weekly-task section including a Weekly Task Sample of preferably one designated Weekly Repeat Task;
the Weekly Task Sample including a selection of abbreviations of entries for five weeks of details relevant to the designated Weekly Repeat Task;
a check mark immediately following the selection of abbreviations of entries for five weeks of details relevant to the designated Weekly Repeat Task reflecting completion in a timely fashion;
the Weekly Task Sample including Weekly Repeat Task-use instructions;
the Weekly Repeat Task-use instructions including when to use, why to use, how to use and benefits from use of the weekly repeat task sheets.
the special-projects section having a plurality of special project sheets for recording no less than one special project per month during a twelve month period;
the Special Project sheets being captioned with predetermined grade-A prompts with a printed SPECIAL PROJECT designation followed by a vacant “DUE DATE” block;
a large vacant box directly beneath THE SPECIAL PROJECT designation being captioned “THE PROJECT” to record the project title;
a large vacant box being directly beneath THE PROJECT box being captioned the “ITEMS NEEDED” for recording items needed to accomplish the project successfully;
a printed designation of “MY PROJECT GAME PLAN” being located directly beneath the vacant ITEMS NEEDED box;
MY PROJECT GAME PLAN including a plurality of vacant target-date spaces for recording deadlines for specific actions that must be taken to complete the project on time with less anxiety and stress;
blank action-item recordation lines being adjacent to the vacant target dates for recording specific actions which must be taken to complete the task on time with less stress and anxiety;
a check space immediately following each recordation line for checking off each action item upon completion;
the Special Project section including a Special Project Sample;
the Special Project Sample including a printed due date, project title and a list of “Items Needed” to accomplish the project successfully;
the Special Project Sample including project-procedure instructions;
the Special Project-procedures including instructions for breaking the project into easily doable portions by working backwards from the final due date to determine a plan of action(s) and the amount of time needed to accomplish the plan to avoid the pain of anxiety from procrastination;

26. The personal success system of claim 1 further comprising:
a four-year reversible calendar.

27. The personal success system of claim 1 further comprising:
at least one Key Contact Sheet being adapted for a responsible adult to record identities and contact data of key educational authorities, including the student, school, phone number, principal, address of school, nurse and teachers. Space for recording “Other Key Contacts” is provided on reverse.

28. The personal success system of claim 1 further comprising:
at least one Attendance Roster being adapted for a responsible adult to record excused and unexcused school absences and comments by the adult or school authorities.

29. The personal success system of claim 1 further comprising:
one 2-page Student Success Diagnostic being adapted for a student to score his or her potential for success through the use of six designated categories, each containing five success-based statements. The “Level of Agreement” section on the Student Success Diagnostic being adapted for the student to rate his or her level of agreement with each success-based statement on a scale of 1-5 (with 5 being the highest) and a vacant block being provided for scoring the result of the self-evaluation for each category.

30. The personal success system of claim 1 further comprising:
one 2-page Student Success Diagnostic Tips Sheet being adapted for offering a student with tips and techniques for success which correspond directly with the six designated categories and five success-based statements within each category provided on the Student Success Diagnostic.

31. A habit builder series comprising:
predeterminedly formatted task sheets for recording and evaluating accomplishment of tasks for achieving personal objectives;
the formatted task sheets including calendar and time format adapted for scheduling tasks yearly, monthly, weekly, daily, and hourly as desired;
the formatted sheets including format for effective and convenient recording of tasks and recording of accomplishment of the tasks for evaluation selectively;
the Habit Builder Series including at least one Flash Action Marker that is formatted for attaching at least one Flash Action Sticky Note titled and adapted for prompting a user to take flash action as needed to accomplish random responsibilities day-by-day that do not require a task slip to avoid stress.
the Habit Builder Series including at least one life-goal sheet that is formatted for recording life goals;
the life-goal sheet having space thereon for recording modifications, changes and updating of the life goals and dreams of accomplishment progressively with increasing cognition and experience;
the personal objectives of the tasks including habit builder prompts for utmost success in any chosen endeavor;
the formatted task sheets in the Habit Builder Series including a plurality of Monthly Overview sheets;
the Monthly Overview sheets in the Habit Builder Series each including one vacant month block for recording the name of each month for one calendar year;
one set of 1-31 date blocks representing each day of any given month and 31 adjacent recordation lines for recording events, activities and responsibilities taking place on each day of the month;
Habit Builder prompts and effective personal-development maxims, quotes, sayings and guides for utmost success selectively;
the Monthly Overview Sample in the Habit Builder Series of preferably no less than seven days with sample selections of abbreviations of entries for a typical week of activities;
the Monthly Overview Sample includes Overview-use instructions;
the Overview-use instructions include when to use, why to use, how to use and benefits from use of the Monthly Overview sheets;
the plurality of Daily Repeat Task sheets in the Habit Builder Series includes a sufficient plurality thereof for recording entries for no less than ten Daily Repeat Tasks during a twelve month period;
the Daily Repeat Task Sheets being captioned with predetermined Habit Builder prompts followed by a space titled “THE TASK” for identifying the task that is to be accomplished on a daily basis and an AM and PM block for recording the preferred time of day to accomplish the task;
the Daily Repeat Task Sheets each including two identical vertical and adjacent recordation columns;
both recordation columns including a vacant Month block for identifying the month in which The (Daily Repeat) Task is to be accomplished;
1-31 date blocks being positioned directly below the Month block representing each day of any given month;
a Recordation line being adjacent to each designated date block for recording relevant details about The (Daily Repeat) Task throughout each corresponding month;
a Check space immediately following the Recordation line for checking the task off upon completion;
the Daily Repeat Task sheets being captioned with predetermined Habit Builder prompts and effective personal-development maxims, quotes, sayings and guides for utmost success selectively;
the daily-tasks section in the Habit Builder Series including a Daily Repeat Task Sample of preferably seven designated date blocks;
recordation lines being adjacent to the designated date blocks showing samples of details relevant to the designated task using a selection of abbreviations of entries;
a checkmark immediately following the recordation lines reflecting completion of the task in a timely manner;
the Daily Repeat Task Sample including Daily Repeat Task-use instructions;
the Daily Repeat Task-use instructions include when to use, why to use, how to use and benefits from use of the Daily Repeat Task sheets;
the weekly-task section having a plurality of Weekly Repeat Task sheets including a sufficient plurality thereof for recording entries for no less than ten Weekly Repeat Tasks during a twelve month period;
the Weekly Repeat Task sheets being captioned with predetermined Habit Builder prompts including a Target week-day designation block and a vacant box titled “THE TASK” followed by AM and PM;
the Weekly Repeat Task Sheet including five sets of Week 1-Week 5 blocks representing each possible week in any given month;
a check space immediately following each Week 1-Week 5 block for checking off the task upon completion;
a Recordation line being adjacent to the check space for recording relevant details about the designated task week-by-week throughout each corresponding month;
the Weekly Repeat Task sheets being captioned with effective personal-development maxims, quotes, sayings and guides for utmost success selectively;
the weekly-task section in the Habit Builder Series including a Weekly Task Sample of preferably one designated Weekly Repeat Task;
the Weekly Task Sample including a selection of abbreviations of entries for five weeks of details relevant to the designated Weekly Repeat Task;
a check mark immediately following the selection of abbreviations of entries for five weeks of details relevant to the designated Weekly Repeat Task reflecting completion in a timely fashion;
the Weekly Task Sample including Weekly Repeat Task-use instructions;
the Weekly Repeat Task-use instructions including when to use, why to use, how to use and benefits from use of the weekly repeat task sheets.
the special-projects section in the Habit Builder Series having a plurality of special project sheets for recording no less than one special project per month during a twelve month period;
the Special Project sheets being captioned with predetermined Habit Builder prompts with a printed SPECIAL PROJECT designation followed by a vacant “DUE DATE” block;
a large vacant box directly beneath THE SPECIAL PROJECT designation being captioned “THE PROJECT” to record the project title;
a large vacant box being directly beneath THE PROJECT box being captioned the “ITEMS NEEDED” for recording items needed to accomplish the project successfully;
a printed designation of “MY PROJECT GAME PLAN” being located directly beneath the vacant ITEMS NEEDED box;
MY PROJECT GAME PLAN including a plurality of vacant target-date spaces for recording deadlines for specific actions that must be taken to complete the project on time with less anxiety and stress;
blank action-item recordation lines being adjacent to the vacant target dates for recording specific actions which must be taken to complete the task on time with less stress and anxiety;
a check space immediately following each recordation line for checking off each action item upon completion;
the Special Project section in the Habit Builder Series including a Special Project Sample;
the Special Project Sample including a printed due date, project title and a list of “Items Needed” to accomplish the project successfully;
the Special Project Sample including project-procedure instructions;
the Special Project-procedures including instructions for breaking the project into easily doable portions by working backwards from the final due date to determine a plan of action(s) and the amount of time needed to accomplish the plan to avoid the pain of anxiety from procrastination;
